(19) United States
(12) Patent Application Publication
(10) Pub. No.: US 2004/0236706 A1
(43) Pub. Date: Nov. 25, 2004

(54) Automated machinery lubrication service and maintenance planning system

(76) Inventors: James Chester Fitch, Tulsa, OK (US); Drew David Troyer, Owasso, OK (US)

Correspondence Address: DUNLAP, CODDING & ROGERS P.C., PO BOX 16370, OKLAHOMA CITY, OK, 73113, US

(21) Appl. No.: 10/835,723

(22) Filed: Apr. 30, 2004

Related U.S. Application Data
(60) Provisional application No. 60/466,566, filed on Apr. 30, 2003.

(51) Int. Cl. H04K 1/00

(52) U.S. Cl. 705/400

(57) ABSTRACT

A method or system for providing service and maintenance information for a piece of equipment to a consumer by analyzing consumer information provided by the consumer. The consumer information about the piece of equipment is requested from the consumer. Consumer information is then received about the piece of equipment and the consumer information is analyzed for the piece of equipment to generate a report containing service and maintenance information based on the consumer information provided by the consumer. The service and maintenance information typically contains at least one oil type information and at least one non-oil type information. The report is then outputted to the consumer so that the consumer can use the report in maintaining the piece of equipment.

### CROSS-REFERENCE TO RELATED APPLICATIONS

The present patent application claims priority under 35 U.S.C. 119(e) to provisional application U.S. Ser. No. 60/466,566, which was filed on Apr. 30, 2003, entitled “AUTOMATED MACHINERY LUBRICATION AND OIL ANALYSIS SYSTEM” the entire contents of which are hereby incorporated in their entirety by reference.

### STATEMENT REGARDING FEDERALLY SPONSORED RESEARCH AND DEVELOPMENT

Not applicable.

### BACKGROUND OF THE INVENTION

1. Field of the Invention

The present invention relates in general to a method and system for providing service and maintenance information for a piece of equipment. In more particular, the present invention relates to providing service and maintenance information to a consumer by analyzing consumer information provided by the consumer of other source of information.

2. Brief Description of the Background Art

Research shows that the overwhelming majority of automotive consumers are confused about engine oils and maintenance such as, by way of example, motor oils, oil filters and preventive maintenance of their vehicles. Consumers are poorly educated concerning the importance of vehicle lubrication and the possible negative consequences of ignoring lubrication or using incorrect lubrication products or maintenance practices. The array of motor oils on retail shelves and the numerous aftermarket services and retrofit additive products are often mind-boggling to even sophisticated car buffs and do-it-yourselfers. For instance, forty years ago there were three motor oil viscosities (light, medium, and heavy). Now there are more than two dozen viscosity options (5W-30, 15W-40, etc.) offered by more than 650 motor oil brands licensed by the American Petroleum Institute (API). A typical auto-parts store such as PEP BOYS™, NAPA AUTO-PARTS™, O'REILLY'S™, etc. will sell several hundred different products related to motor oils, oil filters, and engine treatments.

It is common for automobile owners to receive advice from installers, from quick-lube operators, from mechanics, and from retail clerks that conflicts with the vehicle owner's manuals. Vehicle owner's manuals often recommend oil change intervals nearly twice the length suggested by installers. Auto parts stores, major retailers and installers offer customers hundreds of products that claim to restore horsepower, clean machine parts, protect against friction and heat, clean gums and varnishes, improve machine performance and increase fuel economy, which the owner's manual often says are not needed and may, under certain conditions, be harmful to the vehicle.

Most decisions relating to lubricant type and service interval are highly generalized as practically applied by vehicle owners. However, there are many benefits for individual vehicle owners, fleet owners, the economy and the environment by making proper lubricant type in-service interval decisions. The following are just a few examples: according to GENERAL MOTORS™ and many other organizations, subtle differences in lubrication can affect engine life up to 50 to 70%; tailpipe emissions can be sharply influenced by the quality of lubrication and filtration and; fuel economy can be improved from 2% to 8% by the quality of lubrication. Proper lubrication also results in less demand on nonrenewable energy and substantially lessens the environmental impact from the operation of the vehicle. There is also a potential for substantial reductions in waste oil handling and disposal (from oil changes) when optimal lubricant quality and oil change intervals are selected. Finally, inappropriate oil drain intervals have been shown to increase engine wear by more than 20% with a corresponding reduction in horsepower and fuel consumption by the vehicle.

In general, when machines are properly lubricated, there is less wear and friction. This corresponds to reduced demand on non-renewable fossil fuels. When fossil fuels don't burn, there is no waste stream (smokestack, tailpipe, etc.) and the risk of pollutants from emissions such as nitrogen oxides (the principle component of smog), sulfates, CO₂ and unburned hydrocarbons are reduced proportionally. This results in cleaner air, retarded greenhouse gas emissions and a healthier environment, which is of growing political and social importance in view of the International Kyoto Protocol on global warming, ISO 14001, and the U.S. Clear Air Act.

Thus, there is a need for a method for providing service and maintenance information for a piece of equipment to a consumer. It is to such improved method and system that the present invention is directed.

### SUMMARY OF THE INVENTION

The present invention relates to a method or system for providing service and maintenance information (sometimes referred to herein as “deliverables”) for a piece of equipment to a consumer by analyzing consumer information provided by the consumer or other information sources. The piece of equipment can be, for example, an automobile, truck, marine equipment (personal and commercial), industrial equipment, or the like. The deliverables are extended to apply to any such piece of equipment. In general, consumer information about the piece of equipment is requested from the consumer. For example, the consumer information can be requested in the form of a questionnaire. Consumer information is then received about the piece of equipment from the consumer, and the consumer information is analyzed for the piece of equipment to generate a report containing service and maintenance information based on the consumer information provided by the consumer or other information sources. The service and maintenance information typically contains at least one non-oil type of information, such as recommendations on engine and transmission treatments, engine flushes, oil change intervals, oil filters, air filters, cost benefit analysis or the like.

As optional features, various other information is preferably provided in the report. For example, the information also provides lubrication related maintenance tasks including, but not limited to draining, filling, changing filters, checking oil levels, and visually inspecting oil quality. Information is provided for other oil lubricated power train components including manual and automatic transmissions, differentials, transaxles, and for grease lubricated components which the consumer has frequent interaction with such as chassis and suspension lubricant application locations. The report is then outputted to the consumer so that the consumer can use the report in maintaining the piece of equipment.

In one preferred embodiment, consumers complete a series of questions in an interactive format-online (e.g. utilizing services on or though the World Wide Web or Internet), or utilizing a CD-ROM system or at point-of-sale kiosks at service stations. Other locations include quick lube shops, dealers, parts stores, etc. and individually by the consumer themselves by or through the use of a web enabled cell phone or PDA (personal digital assistant). The answers provided by the consumer (consumer information) to the questions in the list allow an accurate and informative report of lubrication recommendations to be generated. Example questions the customer will answer are as follows: type of application; manufacturer; make, model and year of production; mileage; hours of service; previous product type usage; consistency of product type usage; service history; reliability history; current performance; thermostat setting; oil consumption or loss; driving patterns (city, desert, highway, stop-and-go, heavy load/towing, etc.); climate, including temperature extremes; rain and humidity conditions; dirt and dust levels and type; miles driven per year; type of fuel used; and ownership desires such as fuel economy, machine life, oil change interval or the like.

The system provides service and maintenance information so as to consider and develop the goals of the consumer to the piece of equipment with respect to criteria including but not limited to cost of materials, cost of services, desired reliability of the application, desired life of the application, convenience of service, environmental conservation, frequency of service, performance, and fuel economy. The system provides an informative custom text to build understanding among users of the system of the reasoning behind and significance of the recommendations offered.

The system preferably uses an expert system and algorithms to translate the salient information provided by the customer or consumer to generate the report defining specific recommendations on lubricant type, or viscosity, including non-oil type information, such as filter, engine treatments, oil sample frequency, oil test slate, oil change interval, etc. The quality and depth of analysis in the expert system is believed to go far beyond any generalized (one-size-fits-all) recommendation commonly given by owner's manuals, quick lube technicians, etc. For instance, when the piece of equipment is a vehicle, the following vehicles would have different report recommendations issued by the expert system: a luxury vehicle driving primarily on highway; a vehicle driven by an elderly lady who makes frequent short trips; a muscle vehicle used in motorsports; a high mileage pick-up truck used on dirt roads; an SUV in extremely cold wintertime driving conditions; an ATV in desert terrain driving; a high fuel economy vehicle burning flex fuels (containing alcohol); a high mileage vehicle that burns oil; a vehicle owned by busy professional who often neglects routine maintenance; and a vehicle owned by an auto enthusiast who wants long machine life. The system preferably compiles a database of consumer consumption and use or driving habits. The system also has available historic data as inputs to the algorithm. Oil analysis adds precision to making recommendations on oil type, filtration, oil change intervals, etc. The deliverables by the system are revised periodically as new data from oil analysis, driving conditions, age of vehicle, etc. are updated as long as the piece of equipment is owned by the consumer. As such, the system becomes a living database updated by the consumer periodically for a nominal maintenance fee.

The system over time can compile a huge amount of information about the piece of equipment, its reliability, lubrication practices, consumer habits, consumer preferences, etc. The information comes from the questionnaire that the consumer completes and can be combined with oil analysis data and other sources. This information has the following useful purposes: it can be made available to lubricant suppliers and formulation engineers to better select additives and base oils in new oil motor formulations and can aid in developing marketing campaigns on new lubricant products; it can be made available to designers of the piece of equipment in response to the influence lubrication has on machine reliability, which in turn influences owner manuals and the recommendations on lubricants and oil change interval and can guide machine designers on maintenance and reliability design factors; it can be made available in statistical form to all system consumers, for example, if a consumer owns a certain make, model, and year of SUV, the system can provide a report stating what percentage of other owners of this vehicle use synthetic lubricants, or the average oil change interval, or the average viscosity used, etc.; information regarding reliability problems in the past to a piece of equipment can be compiled from the consumer so as to present statistical information on the reliability of a specific type of piece of equipment to the consumer interested in purchasing the same type of piece of equipment and the system can provide this information to a dealer of the piece of equipment for a fee; the system can also store in a database and report consumer complaints about lubricant related products and services; and the information can be used to advise the U.S. Department of Defense (DOD), U.S. Environmental Protection Agency (EPA), lubricant suppliers, etc. on wasteful environmental and energy consumption practices and the national penalty/opportunity that is available if changes or improvements are made collectively by the consumer (e.g. car owner) public, for example, for an automobile, the system can estimate the environmental impact of changing the average oil change interval from 4,000 to 8,000 miles based on consumer driving habits, oil type preferences, etc.

The system also preferably provides best practice procedures for conducting and interpreting laboratory and home oil analysis for verification of the suitability of the oil for continued service and diagnosis of machine problems including but not limited to acid number for oxidation, crackle test for moisture, and blotter spot test for dispersed performance and fuel or coolant contamination.

Other advantages and features will be recognized by one skilled in the art and in view of the attached drawings, and the appended claims.

### BRIEF DESCRIPTION OF THE SEVERAL VIEWS OF THE DRAWINGS

FIG. 1 is a schematic representation of a machine analysis system constructed in accordance with the present invention.

FIGS. 2a through 2h are consecutive web site screens of questions adapted to elicit personal information and responses from a consumer end user in accordance with the present invention depicted in FIG. 1.

FIGS. 3a through 3d are consecutive web site screens showing an example of a custom report produced from questions answered in FIGS. 2a through 2h.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for purpose of description and should not be regarded as limiting.

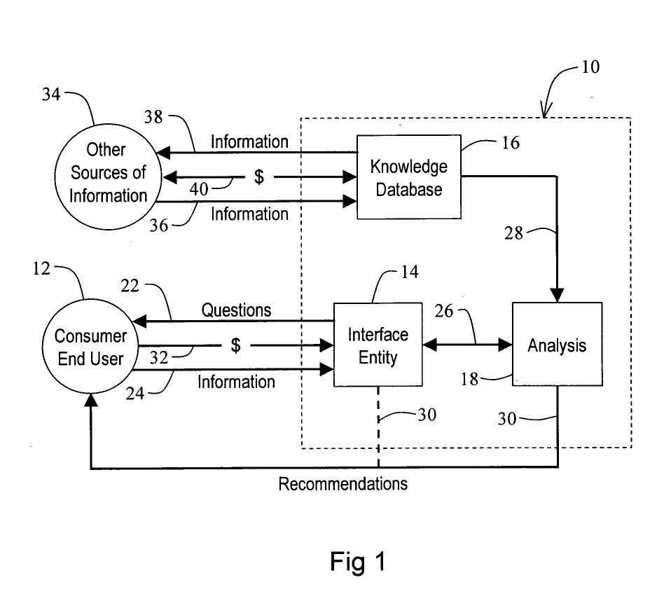

Referring to FIG. 1, shown therein and designated by reference numeral 10 is a machine analysis system constructed in accordance with the present invention. The system 10 recommends preferred service information and maintenance products for a consumer end user 12 based on personal information provided to the system 10 by the consumer end user 12. In general, the system 10 is provided with an interface entity 14, a knowledge data base 16 and an analysis unit 18.

The interface entity 14 outputs a questionnaire to the consumer end user 12 via a signal path 22. The questionnaire includes a set of questions adapted to obtain personal information regarding a piece of equipment associated with the consumer end user 12. The piece of equipment can include a combustion engine and associated supporting machinery such as, a transmission, a drive train, tires, an electrical support system, a fuel system, or the like. For example, the piece of equipment can be (1) a vehicle, such as an automobile, motorcycle, light truck, truck, all-terrain vehicle, snow mobile, boat, personal water craft, bus, airplane, or a semi-truck; (2) farm equipment, such as a tractor, combine, front end loader, or generator; (3) two or four stroke internal combustion consumer products, including, but not limited to lawn or garden type equipment, such as lawnmower, chain saw, string trimmer, edger, tree trimmer, tiller, or the like; or (4) industrial type maintenance equipment, such as backhoe, bulldozer, compaction and paving equipment, concrete and masonry equipment, earth moving equipment, or the like.

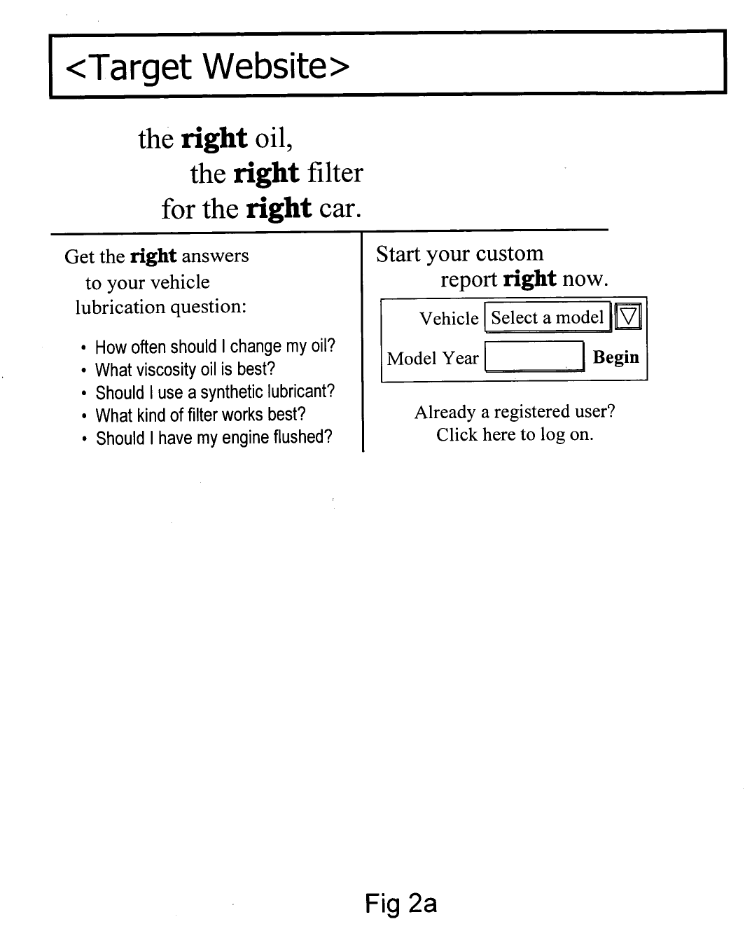

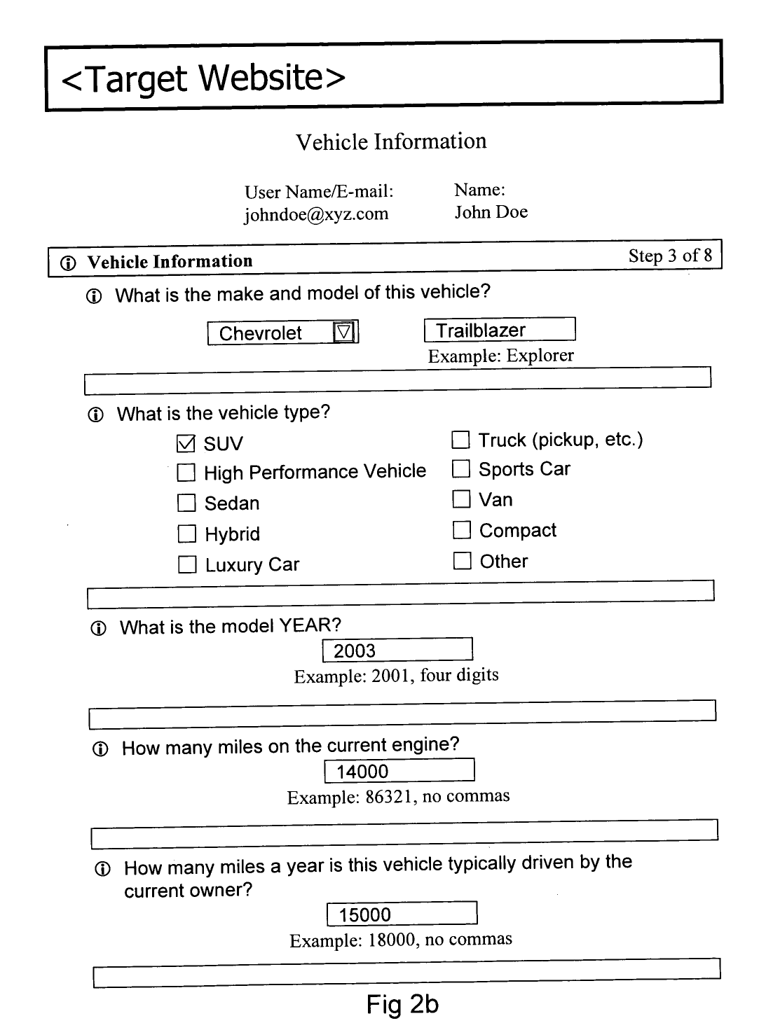

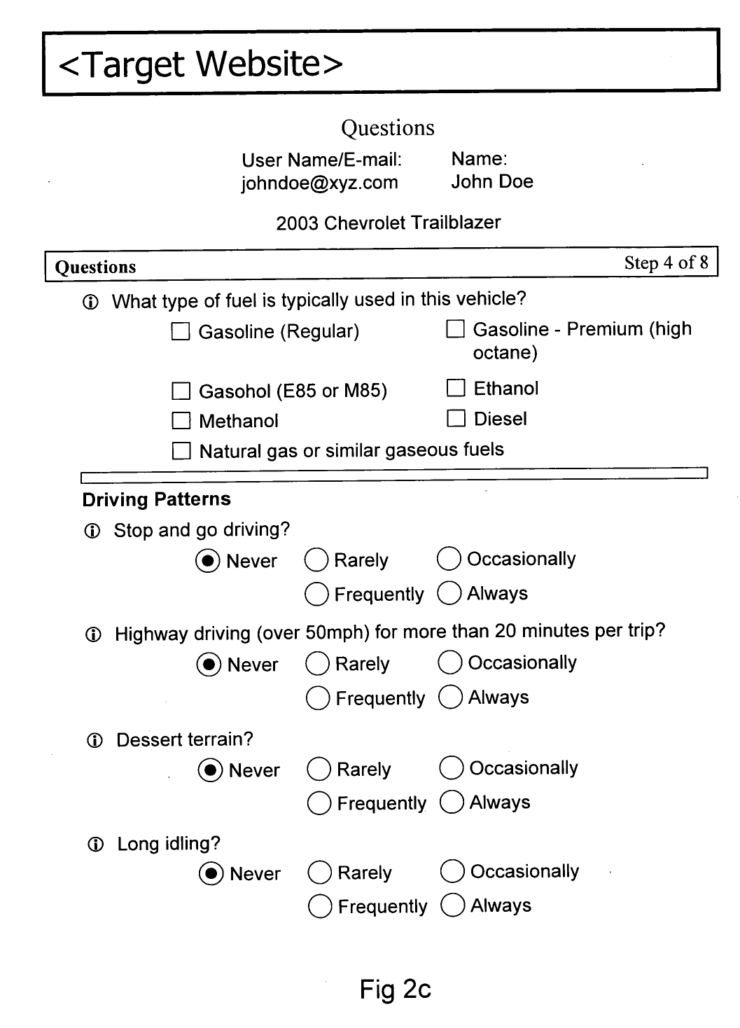

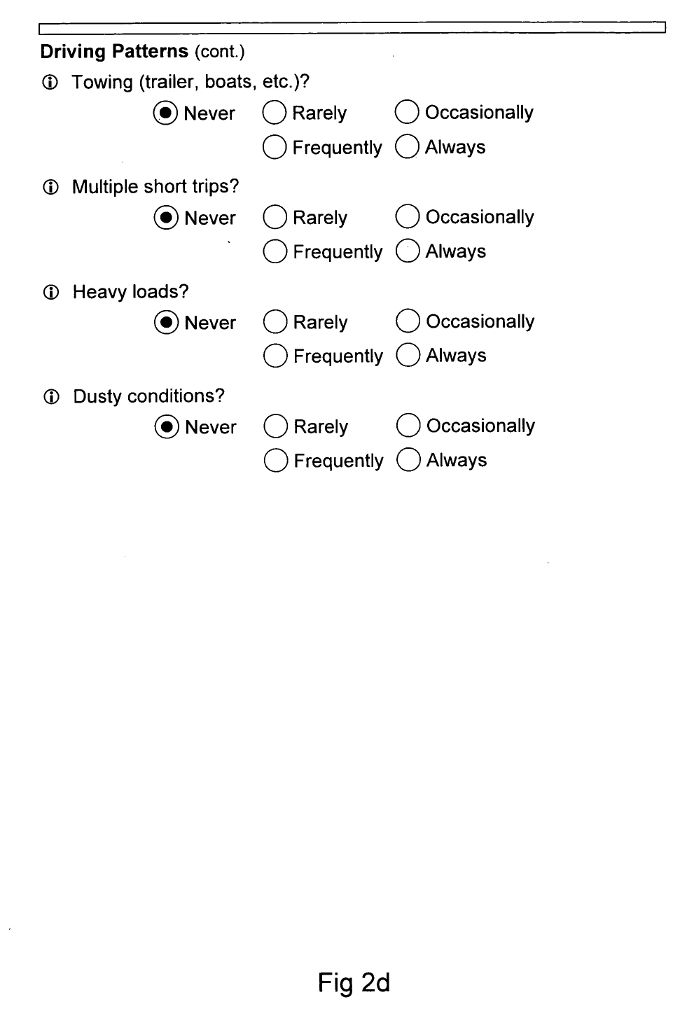

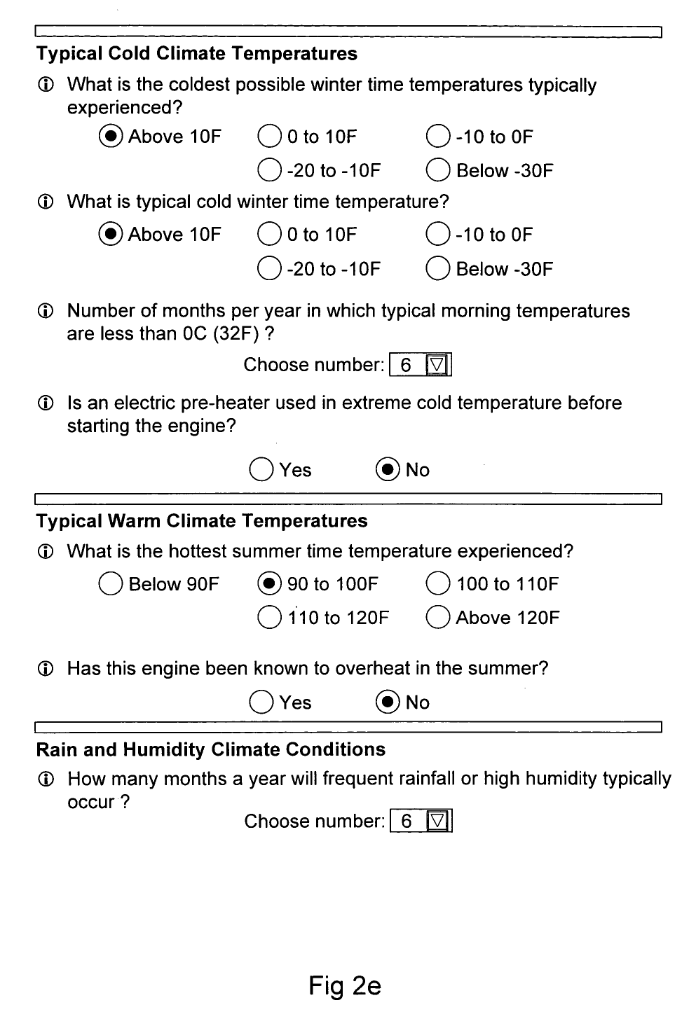

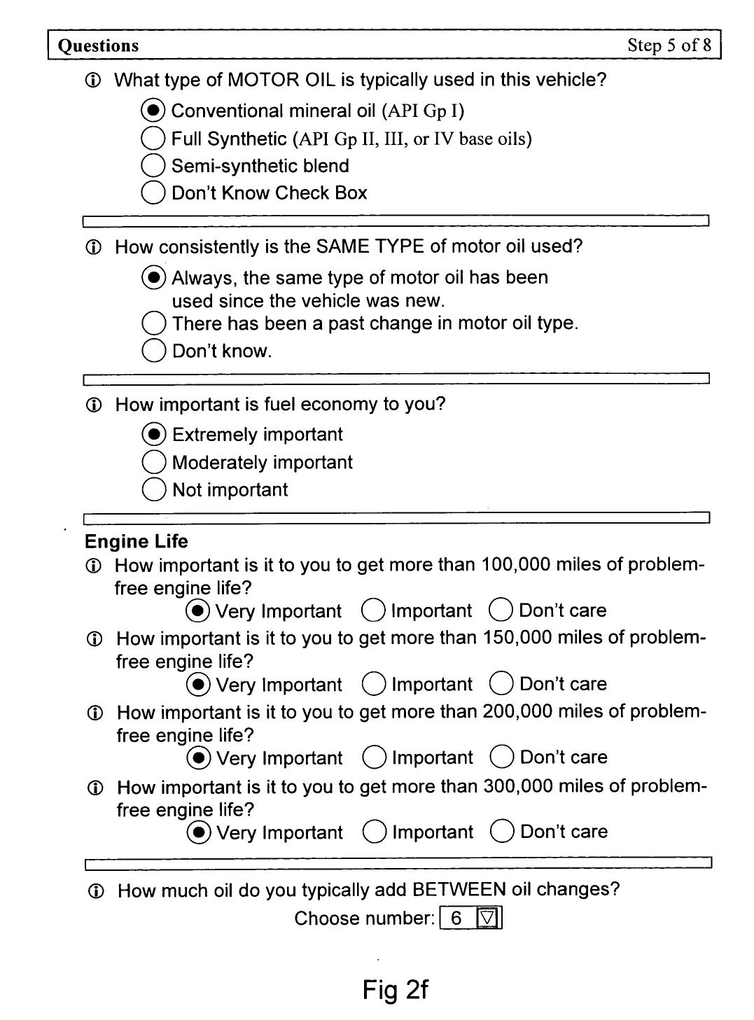

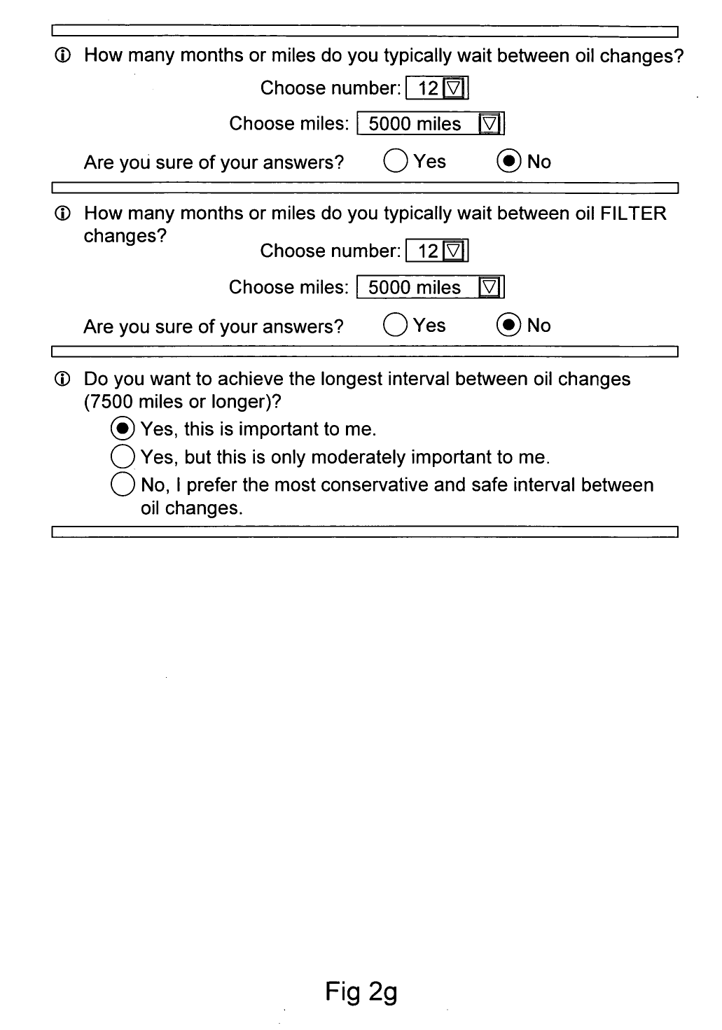

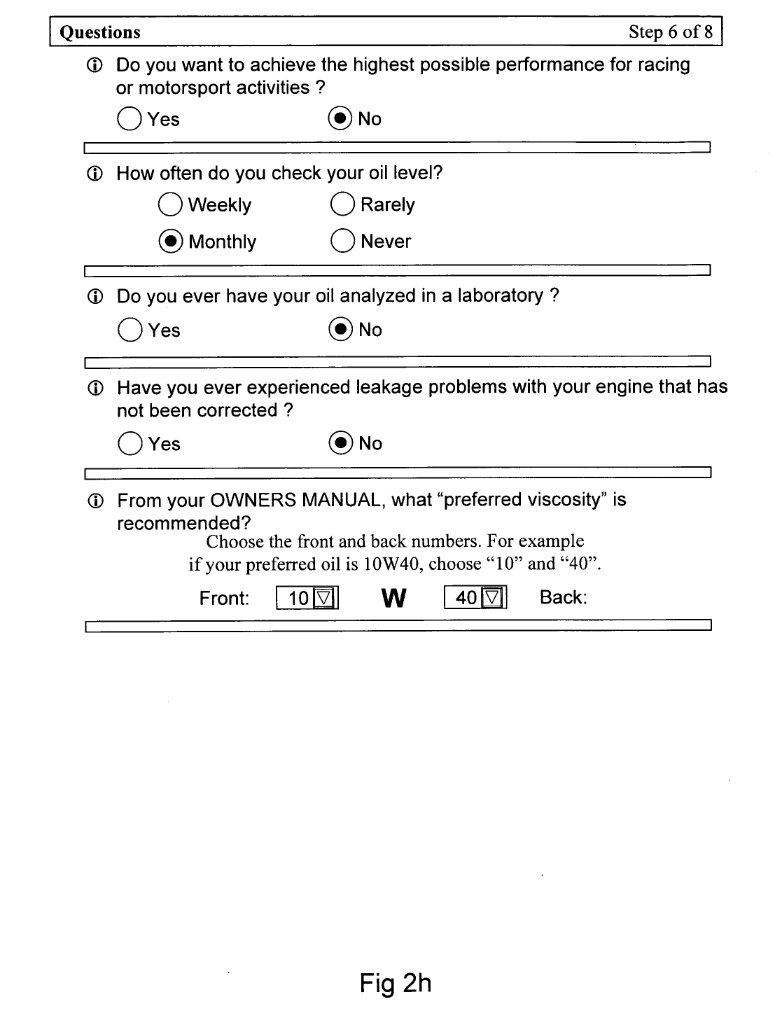

The set of questions in the questionnaire are adapted to elicit personal information or responses with respect to the consumer end user 12 use or other entities' use of the piece of equipment. For example, as shown in FIGS. 2a -2h, a sample questionnaire is shown as being set forth on a website on the World Wide Web (as an example but not to be limiting) which contains example questions which may be contained within the questionnaire for a vehicle. In FIG. 2a, the website requires a consumer to register, so as to be provided with a user name, before entering information or data into the questionnaire. As shown in FIG. 2b, questions regarding vehicle information are requested, including make, model, type, year, current miles, and miles driven per year (or miles boated, or number of hours used, etc. depending upon the type of machine information being entered). In FIGS. 2c and 2d, the web site screen provides questions to gather information regarding fuel type and driving patterns of the consumer. Questions regarding the operation environment of the vehicle are provided in FIG. 2e. In FIGS. 2f-2h, sample questions are requested relating to the consumer's maintenance and desired performance of the vehicle. It should be understood that the questionnaire is not limited to any number of questions, and the type and number of such questions will depend on the piece of equipment to be analyzed (e.g. for a boat, questions such as how important is engine life to you?, do you want to achieve highest possible performance for racing, fishing, or other watersport activities?, may be provided and answered) .

Referring to FIG. 1, the consumer end user 12 can pay for the analysis of the piece of equipment by any suitable payment medium, such as cash, credit card, debit card, or any other such valuable consideration via signal path 32.

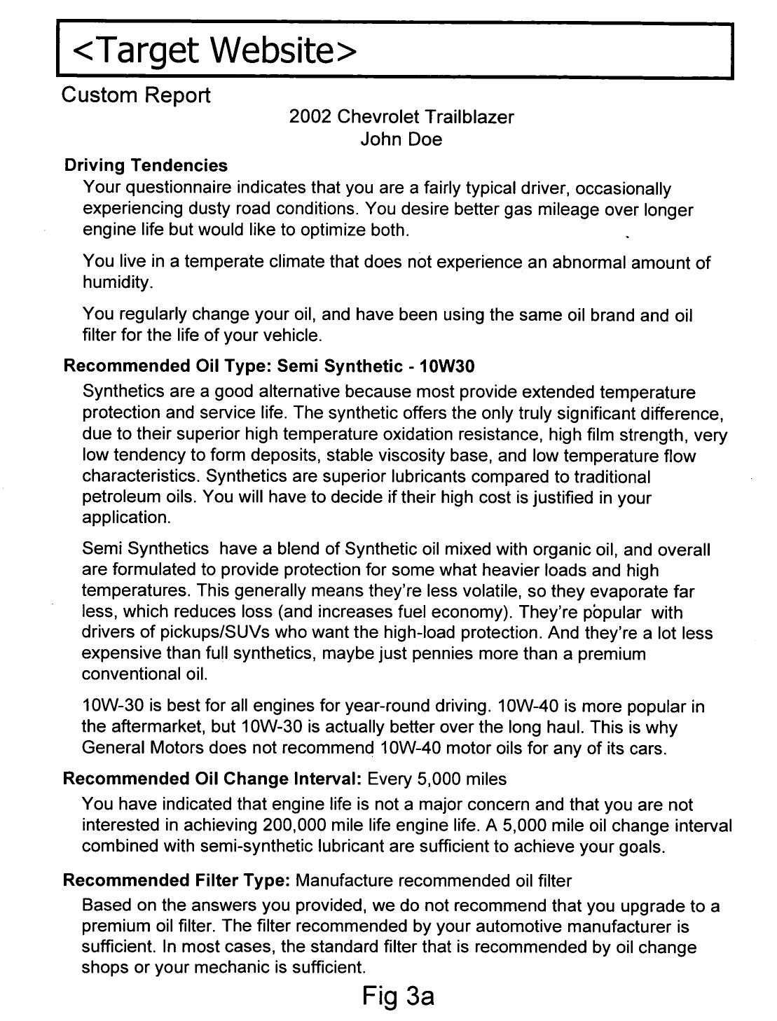

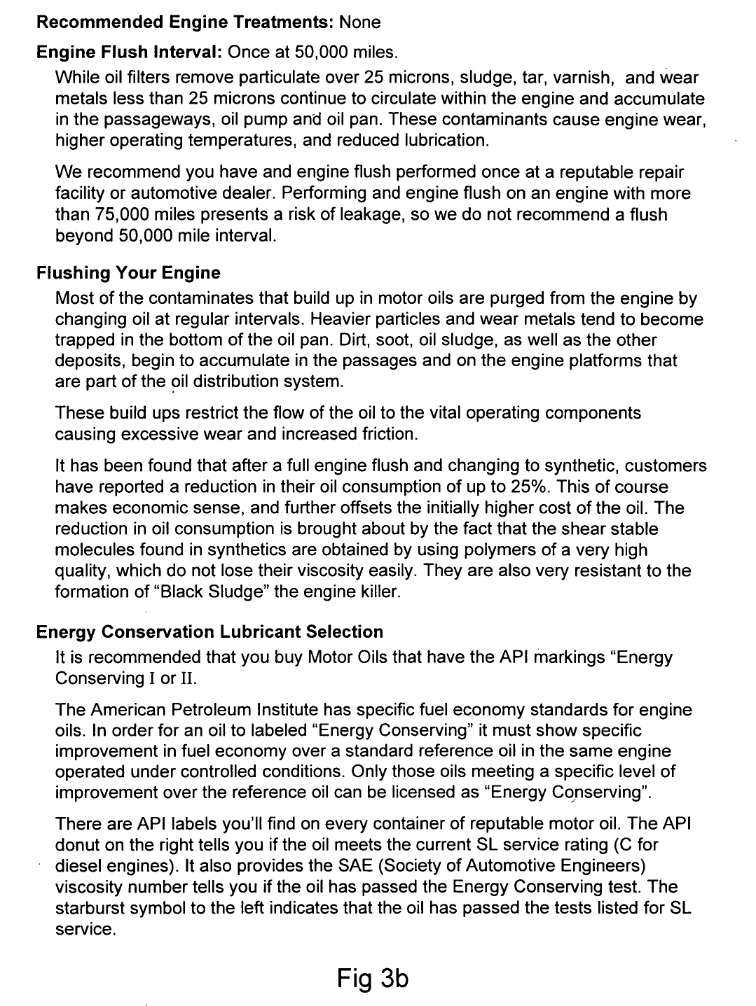

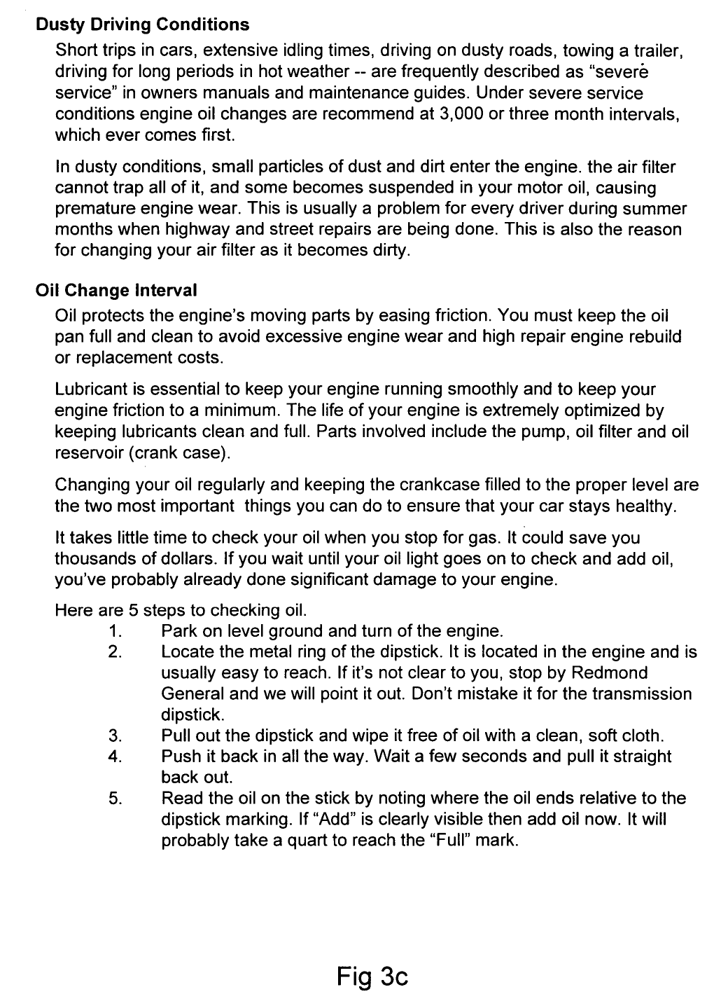

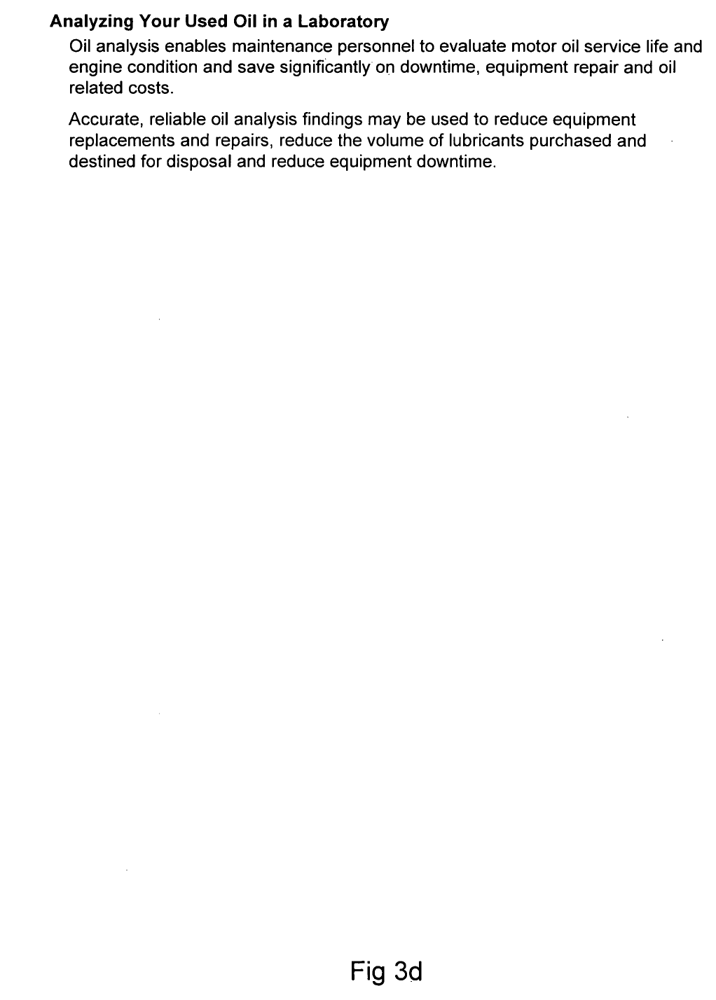

As will be discussed in more detail below, the interface entity 14 or the analysis unit 18 outputs a custom report such as the custom report shown in (FIGS. 3a -3d) or other forms of information via a signal path 30, respectively, indicative of recommendations regarding preferred service information or maintenance products for the piece of equipment. As shown in FIGS. 3a-3d, a “mock report” or “custom report” is provided to show an example of the information produced with respect to the piece of equipment being an automobile. Preferably, deliverables are organized in this concise report without mention of specific products or brands. For example, the deliverables are the customized answers to consumer questions such as: Should I use synthetic oil in my car (or conventional mineral or synthetic blend)?; Is it safe to switch from a mineral oil to a synthetic in my application?; How often should I change my oil?; What's the best oil viscosity for my car (mono-grade, multigrade, front number, back number, etc.)?; When should I flush my engine, if at all?; Should I put engine treatments in my oil?; Do I need to use a high-mileage oil formulation?; Do I need to use a premium oil filter? If so, what performance specification should I look for? Should I use a by-pass filter?; Should I use a special motor oil designated by the API as “Energy Conserving”? However, it should be understood that analysis, recommendations, and commentary for the selection and use of commercially available after market oil treatments and additive packages may also be provided. It should be understood that other types of reports can be produced in accordance with the present invention depending on the particular type of equipment which is being analyzed.

The knowledge data base 16 contains information regarding service or maintenance for a variety of pieces of equipment and/or types of equipment. For example, the knowledge data base 16 can be adapted to work only for one particular type of equipment, such as an automobile, and in such cases the knowledge data base 16 will contain a variety of service and/or maintenance product information for a variety of makes and models of vehicles. The knowledge data base 16 can also contain service or maintenance product information for a plurality of different types of equipment, such as automobiles, motorcycles, or farm equipment. The system 10 allows for upgrading and updating the knowledge database 16 without requiring modifications to any software. The knowledge database 16 is provided with information from other sources of information 34 via a signal path 36. The other sources of information 34 can be a single informational source or a network of informational sources (e.g. equipment manufacturers and suppliers, lubricant formulators, manufacturers and suppliers, parts manufacturers and suppliers, laboratory oil analysis, environmental and other agencies, etc.). The updated information is provided by the other sources of information 34 as batched, periodic or real-time data and can be sold or traded to the system 10 by any suitable payment medium, such as cash, credit card, debit card, or any other such valuable consideration via signal path 40, although the information may be given away gratis by the owner of the other sources of information 34.

Over time, the knowledge database 18 compiles a large amount of information about a piece of equipment, its reliability, lubrication practices, consumer end use habits, consumer end user preferences, etc. This compiled information comes from the combined responses provided by the consumer end user 12 to the questionnaire and can be combined with analysis data and information 36 from the other sources of information 34. This mined data and information can be provided to third parties including the other sources of information 34, as well as, equipment manufacturers and suppliers, lubricant formulators, manufacturers and suppliers, parts manufacturers and suppliers, laboratory oil analysis, environmental and other agencies, etc. via a signal path 38. The mined information can be sold or traded by the system 10 to the other sources of information 34 by any suitable payment medium, such as cash, credit card, debit card, or any other such valuable consideration via signal path 40, although the information may be given away gratis by the owner of the system 10.

The analysis unit 18 receives the personal information from the interface entity 14 via a single path 26, and information from the knowledge data base 16 is received by the analysis unit 18 via a signal path 28 and generates the custom report with the use of the knowledge data base 16. The signal paths 22, 24, 26, 28, 30, 32, 34, 36 and 38 can be either manual signal paths, or electronic communication signal paths. The electronic communication signal paths can be logical and/or physical links between various software and/or hardware utilized to implement the present invention. The physical links could be air-way or cable communication links. When the invention is implemented, the signal paths may be separate signal paths, a single signal path, or multiple signal paths. In addition, it should be understood that the various information does not have to flow between the components of the present invention in the exact manner shown provided the information is generated and received to accomplish the purposes set forth herein.

The signal path 24 can be any type of communication capable of communicating the personal information from the consumer end user 12 to the interface entity 14. For example, the signal path 22 can take the form of a direct mail document(s), the Internet (and in this case the interface entity 14 would be a website on the World Wide Web), a personal use device, such as a keyboard, mouse, or a microphone (and in this case the interface entity 14 would typically be a kiosk provided at a trade show, automotive club venues, motor sports venues, automotive dealer location, point of sale location, or other retail or service location), or the like.

The signal path 22 can be any type of communication link capable of communicating the questions to the consumer end user 12. For example, the signal path 24 can take the form of a sales call, email message, a fax, a direct mail document(s), the Internet (and in this case the interface entity 14 would be a website on the World Wide Web), a personal use device, such as a keyboard, mouse, or a microphone (and in this case the interface entity 14 would typically be a kiosk provided at a trade show, point of sale location, or retail or service location) or the like.

The interface entity 14, the consumer end user 12, the knowledge data base 16, and the analysis unit 18 can be provided in either a same location, or separate locations depending on the architecture and the type of system implementation as long as they provide service and maintenance information for a piece of equipment to a consumer.

The analysis unit 18 can generate an estimate of the savings and benefits the consumer end user 12 may obtain by following the recommended changes provided by the analysis unit 18. For example, improvement in oil and fuel economy, improved machine life, higher combustion efficiency, reduction to tailpipe emissions, and the like. The personalized cost/benefit analysis is provided to the consumer end user 12 before the consumer end user 12 commits to pay for the service. Once the consumer end use 12 answers the questionnaire, the benefits statement and economic analysis is generated based on the difference between what the consumer end user 12 is doing currently (relating to lubrication) and the value gained relating to the proposed (but undisclosed) changes that will be made to improve lubrication. If the consumer end user 12 likes the estimated benefits he will receive, then he can pay to receive the specific recommendations (deliverables) provided by the system 10. For example, the following are the types of estimated savings that will be reported on the benefits statement: annual oil consumption savings, if any, from optimizing the lubricant drain interval and lubricant quality selection, plus reduced oil consumption from improved engine lifetime combustion efficiencies; annual filter consumption savings, if any, from optimizing the filter change interval and filter quality selection; annual fuel economy savings from improved engine lifetime combustion efficiencies and improved energy conserving properties of lubricant selection (energy conserving additives, viscosity, etc.); percent estimated increase in operating life (durability) of the machine; and annual estimated environmental benefits from improved combustion efficiencies, reduced fuel consumption, reduced tailpipe emissions, reduced oil and filter consumption, reduced catalyst contamination (phosphorus limits), etc. It should be understood that the various estimated savings reported will vary depending on the piece of equipment.

Further, the system 10 can provide a communication link directing the consumer end user 12 to a list of vendors to perform the recommended services or provide the recommended parts. This allows the consumer end user 12 to select the vendor of his/her choice from the list to perform the services and/or provide the parts as recommended by the analysis unit 18 to the piece of equipment. For example, a link from a website on the World Wide Web can provide the consumer end user 12 with a list of labs or lab websites that allows the consumer end user 12 to obtain an oil analysis. Other links may provide a list of lubricants, filters, or the like that meet the recommended changes or conditions from the analysis unit 18.

The personal information accumulated and stored by the system 10 represents feedback information regarding the usage of the pieces of equipment. The personal information can be mined to provide marketing information or usage information on particular types of equipment or particular types of end users. The personal information can also be distributed. Software and/or data representing the knowledge data base 16, analysis unit 18, and the interface entity 14 can be stored on a computer readable medium capable of storing information in a format that can be read by a computer. For example, the computer readable medium can be a hard disk, an optical or a magnetic disk, a CD-ROM, a DVD, a tape drive, a memory device (portable or not portable) or the like. The computer readable medium or the information thereon can be distributed. The system 10 allows for upgrading and updating the knowledge database 16 without requiring modifications to any software. The system 10 is platform independent to allow for application via yet undeveloped media.

From the above description it is clear that the present invention is well adapted to carry out the objects and to attain the advantages mentioned herein as well as those inherent in the invention. While one embodiment of the invention has been described for purposes of this disclosure, it will be understood that numerous changes may be made which will readily suggest themselves to those skilled in the art and which are accomplished within the spirit of the invention disclosed herein and defined in the appended claims.

What is claimed is:

1. A method for providing service and maintenance information for a piece of equipment to a consumer by analyzing consumer information provided by the consumer, the method comprising the steps of:
receiving the consumer information about the piece of equipment;
analyzing the consumer information for the piece of equipment; and
outputting a report containing service and maintenance information to the consumer for the piece of equipment based on the consumer information, wherein the service and maintenance information contains at least one oil type information and at least one non-oil type information.

2. The method of claim 1 further comprising:
requesting the consumer information about the piece of equipment from the consumer.

3. The method of claim 1, wherein the consumer information is at least one of the type of the piece of equipment and the history of use of the piece of equipment.

4. The method of claim 3, wherein the history of use of the piece of equipment is at least one of environment of use, operational characteristics, ownership objectives, and service and maintenance history.

5. The method of claim 1 wherein the non-oil type information is at least one of engine treatment, transmission treatment, engine flush, oil change interval, filter type, and cost-benefit analysis of the service and maintenance information.

6. The method of claim 1 wherein in the step of requesting consumer information about the piece of equipment from the consumer, a questionnaire is displayed on a computer screen wherein the questionnaire is associated with a website on the internet.

7. The method of claim 1 wherein in the step of requesting consumer information about the piece of equipment from the consumer, questions are provided to the consumer with a sales call, electronic mail, a direct mail document, internet website, and a personal use device.

8. The method of claim 1 wherein in the step of outputting the report containing service and maintenance information to the consumer, the report is outputted to a computer.

9. The method of claim 1 wherein in the step of outputting the report containing service and maintenance information to the consumer with a manual or electronic signal path.

10. A method for providing service and maintenance information for a piece of equipment to a consumer by analyzing consumer information provided by the consumer, the method comprising the steps of:
requesting consumer information about the piece of equipment from the consumer from an interface entity;
receiving, by the interface entity, consumer information about the piece of equipment from the consumer;
transmitting consumer information for the piece of equipment from the interface entity to an analysis unit;
analyzing, by the analysis unit, consumer information for the piece of equipment; and
outputting a report containing service and maintenance information to the consumer for the piece of equipment based on the consumer information provided by the consumer from the interface entity, the service and maintenance information containing at least one oil type information and at least one non-oil type information.

11. The method of claim 10, wherein the interface entity is positioned at a point of transaction.

12. The method of claim 10, further comprising the step of transmitting information from a knowledge data base to the analysis unit.

13. The method of claim 12 wherein the knowledge database is provided with updated data from an information source.

14. The method of claim 13 wherein the updated data is provided by the information source as batched, periodic or real-time data.

15. The method of claim 10 wherein in the step of requesting consumer information about the piece of equipment from the consumer, a questionnaire is displayed on a computer screen of the interface entity and wherein the questionnaire is provided to the interface entity by a website.

16. A device for causing an interface entity to provide service and maintenance information for a piece of equipment to a consumer by analyzing consumer information provided by the consumer, comprising:
a computer readable medium storing instructions including:
program code for causing the interface entity to request consumer information about the piece of equipment from the consumer;
program code for causing the interface entity to receive consumer information about the piece of equipment from the consumer;
program code for causing the interface entity to transmit consumer information for the piece of equipment from the interface entity to an analysis unit;
program code for causing the analysis unit to analyze consumer information for the piece of equipment; and
program code for causing the interface entity to output a report containing service and maintenance information to the consumer for the piece of equipment based on the consumer information provided by the consumer from the interface entity, the service and maintenance information containing at least one oil type information and at least one non-oil type information.

17. The device of claim 16 wherein the computer readable medium is provided with an algorithm to translate the consumer information provided by the consumer for the piece of equipment to generate the report containing service and maintenance information.

18. A method for providing consumer information for a piece of equipment to a third party by analyzing the consumer information provided by at least one of a consumer and a third party, the method comprising the steps of:
receiving the consumer information about the piece of equipment from at least one of the consumer and the third party;
analyzing the consumer information for the piece of equipment; and
providing the consumer information about the piece of equipment to a third party, the consumer information containing at least one of data provided by the consumer, data provided by the third party and the analysis of the consumer information.
